(19) United States
(12) Patent Application Publication
(10) Pub. No.: US 2002/0122459 A1
(43) Pub. Date: Sep. 5, 2002

(54) Passively cooled high temperature capable probe housing

(76) Inventors: Dawn Key McFarland, Lebanon, IN (US); Timothy John Turk, Plainfield, IN (US); Andrew John Brewington, Indianapolis, IN (US); Lance Edward Groseclose, Indianapolis, IN (US); Pramod Khandelwal, Indianapolis, IN (US)

Correspondence Address: John H. Allie, Esquire, Woodard, Emhardt, Naughton, Moriarty and McNett, Bank One Center/Tower, 111 Monument Circle, Suite 3700, Indianapolis, IN, 46204-5137, US

(21) Appl. No.: 09/748,969

(22) Filed: Dec. 27, 2000

(51) Int. Cl. G01K 7/04; G01K 1/14; G01K 13/02; G01K 1/08

(52) U.S. Cl. 374/179; 374/166; 374/138; 374/135; 374/147

(57) ABSTRACT

A high temperature capable probe housing for use in a gas turbine engine is disclosed. The rake is preferably made of silicon nitride or silicon carbide and is capable of withstanding the hostile environment within a gas turbine engine at temperatures greater than 1,200 Celsius while only passively cooled. The rake is a substantially elongated member extending between an at least partially open first end and a closed second end. The rake has an interior surface and an exterior surface. The interior surface defines an internal cavity beginning at the at least partially open first end and extending toward the closed second end. The exterior surface extends between the two ends and has a leading face having a plurality of openings upon which the flow generally impinges. The openings extend between the exterior surface and interior surface and are configured to receive a sensor.

This invention was made with U.S. Government Support under Contract Numbers 200-1X-14D42103, 14N 44579 and F3615-95-C-2502 and the U.S. Government has rights therein.

### BACKGROUND OF THE INVENTION

Instrumentation for measuring data about the hot gas flow within a gas turbine engine encounters a hostile operating environment, particularly at the turbine exhaust. This hostile environment is due to both the mechanical stress caused by the high velocity fluids impinging upon the instrumentation as well as the thermal stress caused by the elevated temperatures. Other mechanical and thermal stress may be due to things such as impact caused by step changes in pressure, vibration, thermal shock, reaction of materials with exhaust gases and loading.

In many prior designs the instrumentation is carried in a multi-element device called a rake, which generally was formed of metallic superalloys or noble metal alloys. The rake designs using metallic materials were limited to temperature operating environments of up to 1,200 degrees Celsius or required complex active cooling schemes that disturbed the accuracy of measurement. Previously utilized superalloys experience a sharp loss in strength (drop in yield strength) at temperatures above 1,600-1,800 degrees Fahrenheit. Platinum, while capable of withstanding elevated temperatures grows soft and is unable to withstand aerodynamic loading even when alloyed with rhodium. Additionally, platinum is expensive.

There remains a need for a passively cooled high temperature probe housing capable of withstanding hostile operating environments associated with gas turbine engines. The present invention satisfies this need in a novel and nonobvious way.

### SUMMARY OF THE INVENTION

In one embodiment of the present invention there is contemplated a probe housing, comprising: an elongated ceramic member extending between a first end and a second end and having an exterior surface including a leading face adapted for receiving fluid flow thereon, the member having an internal cavity, the member having a plurality of openings defined on the leading face and extending between the exterior surface and the internal cavity and each of the plurality of openings configured to receive a sensor therein, and wherein the member is capable of withstanding hot gases impinging on said exterior surface at temperatures greater than 1200 degrees Celsius while the member is only passively cooled.

In another form of the present invention there is contemplated a combination, comprising: a substantially elongated silicon nitride sensor housing having a mounting end and a flowpath end and an internal cavity, the housing having a substantially airfoil shaped outer surface extending between the mounting end and the flowpath end and having a leading face adapted to be generally oriented to receive a fluid flow impinging thereon and a trailing face, the housing having a plurality of openings defined on the leading face extending between the internal cavity and the outer surface; and a temperature sensor includes a thermocouple, the thermocouple is part of a button that is inserted into one of the plurality of openings.

In yet another form of the present invention there is contemplated a high temperature capable probe housing, comprising: a substantially elongated silicon nitride member, the member extending between an at least partially open mounting end and a closed flowpath end, the member having an inner surface and an outer surface, the inner surface defining a cavity beginning at the mounting end and extending toward the flowpath end, the outer surface extending between the mounting end and the flowpath end, the outer surface being substantially airfoil shaped and having a leading face upon which the flow generally impinges and a trailing face, the member having a plurality of openings defined on the leading face extending between the inner surface and the outer surface, and wherein each of the plurality of openings is configured to receive a sensor.

In yet another embodiment of the present invention there is a high temperature probe housing comprising a core piece and a shield. The shield may be metallic or ceramic. The core piece has an outer surface and an inner surface. The outer surface extends between a partially open first end and a closed second end. The inner surface defines a cavity. The outer surface has a plurality of openings, each opening capable of receiving a sensor and each opening extending between the outer surface and the inner surface. The openings are on the leading face of the outer surface. The first end and at least a portion of the outer surface of the core piece are enclosed by the shield. There is preferably a gap between the interior surface of the shield and the outer surface of the core piece. In one preferred form the shield has a cylindrical portion and an end portion. The cylindrical portion surrounding a portion of the core piece, the end portion defining a recess configured to receive a mounting flange formed on the first end of the core piece.

One object of the present invention is to provide a unique probe housing.

Related objects and advantages of the present invention will be apparent from the following description.

### BRIEF DESCRIPTION OF THE DRAWINGS

FIG. 1 is a generic representation of an aircraft with a gas turbine.

FIG. 2 is a schematic representation of the components of the generic gas turbine engine of FIG. 1.

FIG. 3 is a side view of one embodiment of the present invention.

FIG. 4 is a side view of the embodiment of FIG. 3 assembled with a shield and a retainer.

FIG. 5 is an exploded perspective view illustrating various components of the embodiment of FIG. 4.

FIG. 6 is a bottom partial sectional view of the embodiment illustrated in FIG. 4.

FIG. 7 is a side partial sectional view of another embodiment of the present invention.

FIG. 8 is a view along lines A-A of FIG. 7.

FIG. 9 is a view along lines B-B in FIG. 7.

FIG. 10 is a top view of the embodiment of FIG. 7 along the line C.

FIG. 11 is a side view of another embodiment of the present invention mounted within a gas turbine engine.

FIG. 12 is a rear view of another embodiment of the present invention.

FIG. 13 is a partial sectional view along lines A-A of FIG. 12.

FIG. 14 is an enlarged view of a portion of FIG. 13.

FIG. 15 illustrates another embodiment of a sensor that may be used in the present invention.

### DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

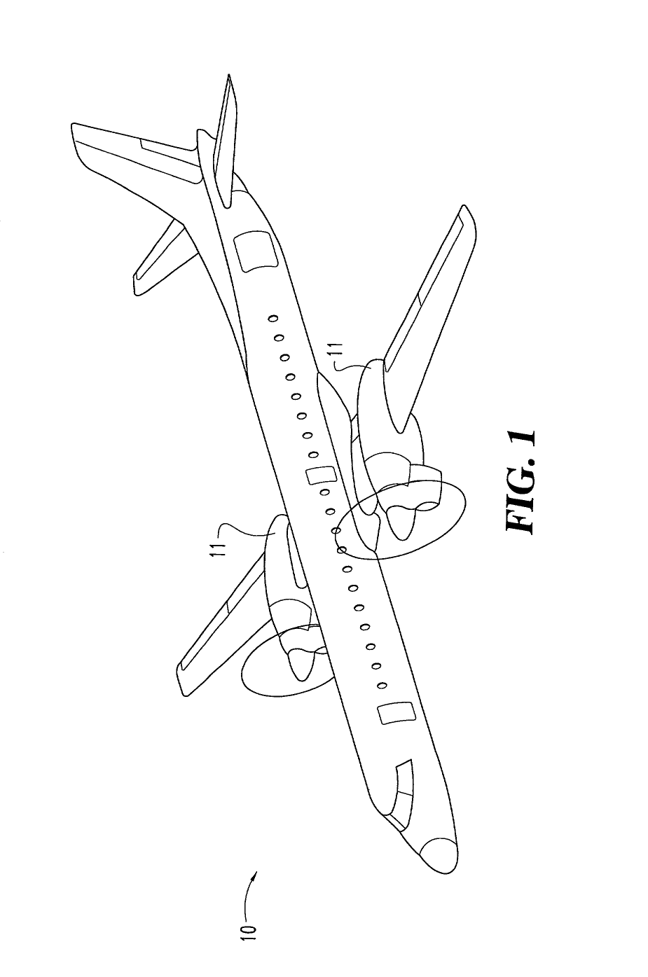

Referring to FIG. 1, there is illustrated a representation of an aircraft 10 powered by gas turbine engines 11. The term aircraft is generic and includes helicopters, airplanes, and missiles, unmanned space devices and any other substantially similar devices.

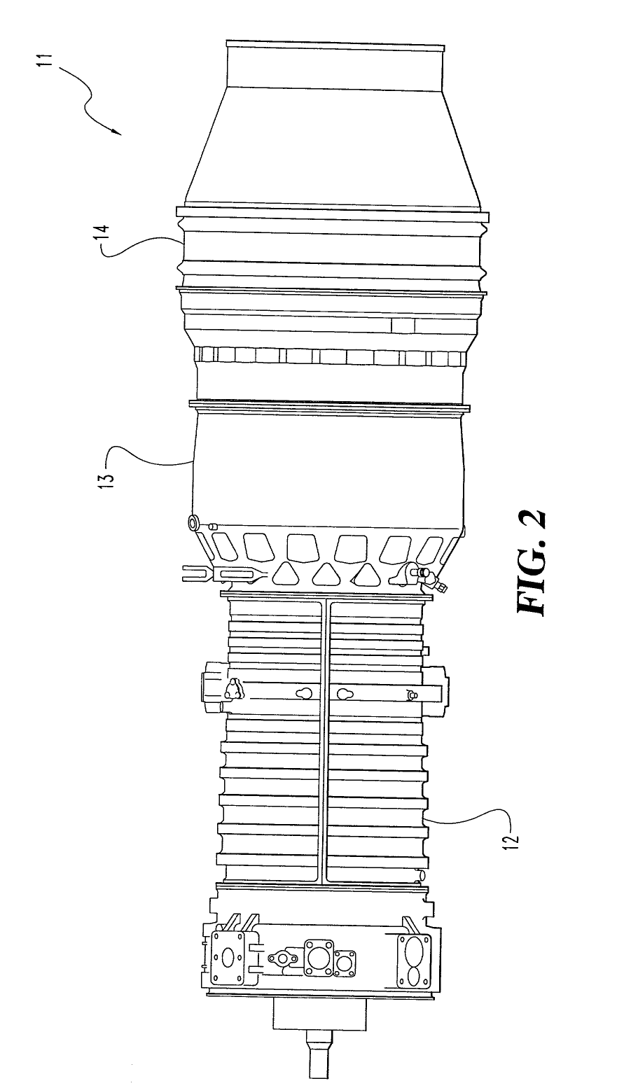

Referring to FIG. 2, there is illustrated a schematic representation of a gas turbine engine 11 that includes a compressor section 12, a combustor section 13, and a turbine section 14 that are integrated together to produce an aircraft flight engine. One alternate form of a gas turbine engine includes a compressor, a combustor, a fan section, and a turbine that have been integrated together to produce an aircraft flight propulsion engine, that is generally referred to as a turbo-fan. It is important to realize that there are multitudes of ways in which the gas turbine engine components can be linked together. Additional compressors and turbines could be added with intercoolers connecting between the compressors, and reheat combustion chambers could be added between the turbines. Further details related to the principles and components of a conventional gas turbine engine will not be described herein as they are believed known to one of ordinary skill in the art. A gas turbine engine is equally suited to be used for an industrial application. Historically, there has been widespread application of industrial gas turbine engines, such as pumping sets for gas and oil transmission lines, electricity generation, and naval propulsion.

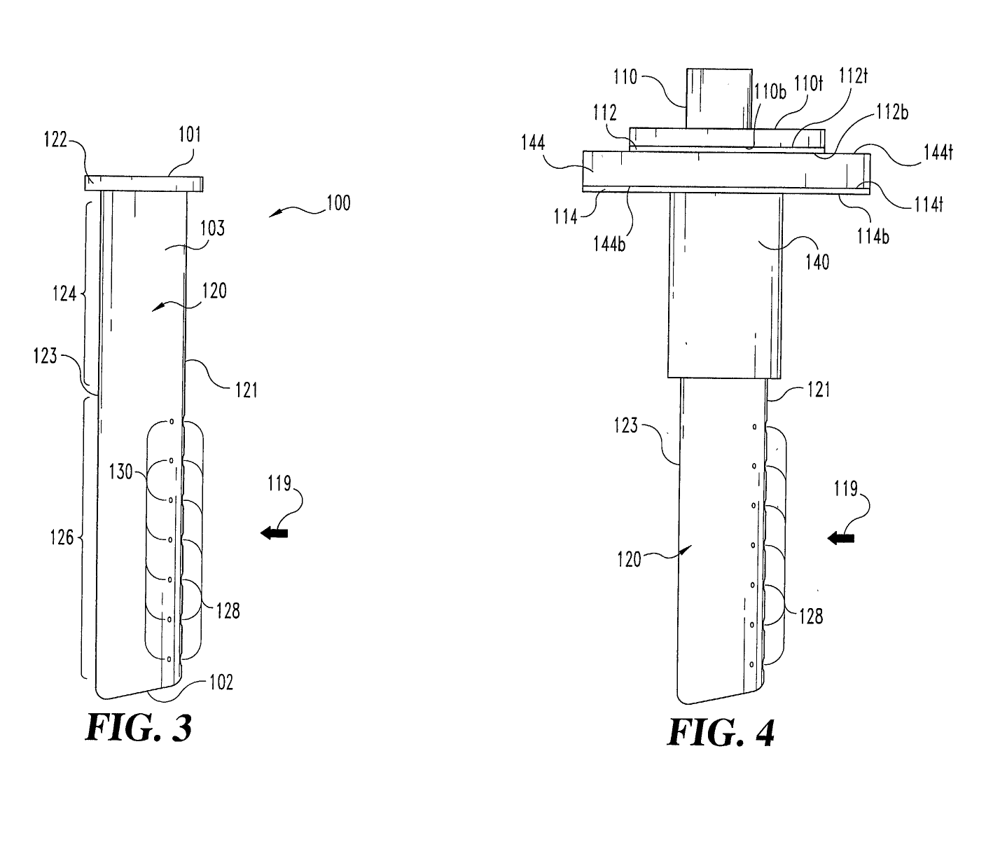

With reference to FIG. 3 there is illustrated one form of the present invention. The probe housing or rake 100 is a core piece 120 that has a first or mounting end 101 that is at least partially open and a second or flowpath end 102 that is closed. An exterior or outer surface 103 extends between the mounting end 101 and the flowpath end 102. The outer surface 103 defines a mounting flange 122 at the mounting end 101. As illustrated in FIG. 3 the core piece 120 is a substantially elongated member extending between the mounting end 101 and the flowpath end 102 having a leading face 121 and a trailing face 123. The leading face 121 of the core piece 120 has a plurality of openings 128 preferably with associated bleed holes 130. The leading face 121 of the core piece 120 being that which the flow (indicated by the arrow 119) first encounters. When used in conjunction with a shield 140, as discussed below, the core piece 120 may be thought of as having two different portions along its radial length. The first is the hot gas flow portion 126 upon which the flow 119 directly impinges. The second is the shielded portion 124 that the flow 119 may or may not impinge directly upon depending on whether the core piece 120 is used in conjunction with a shield 140.

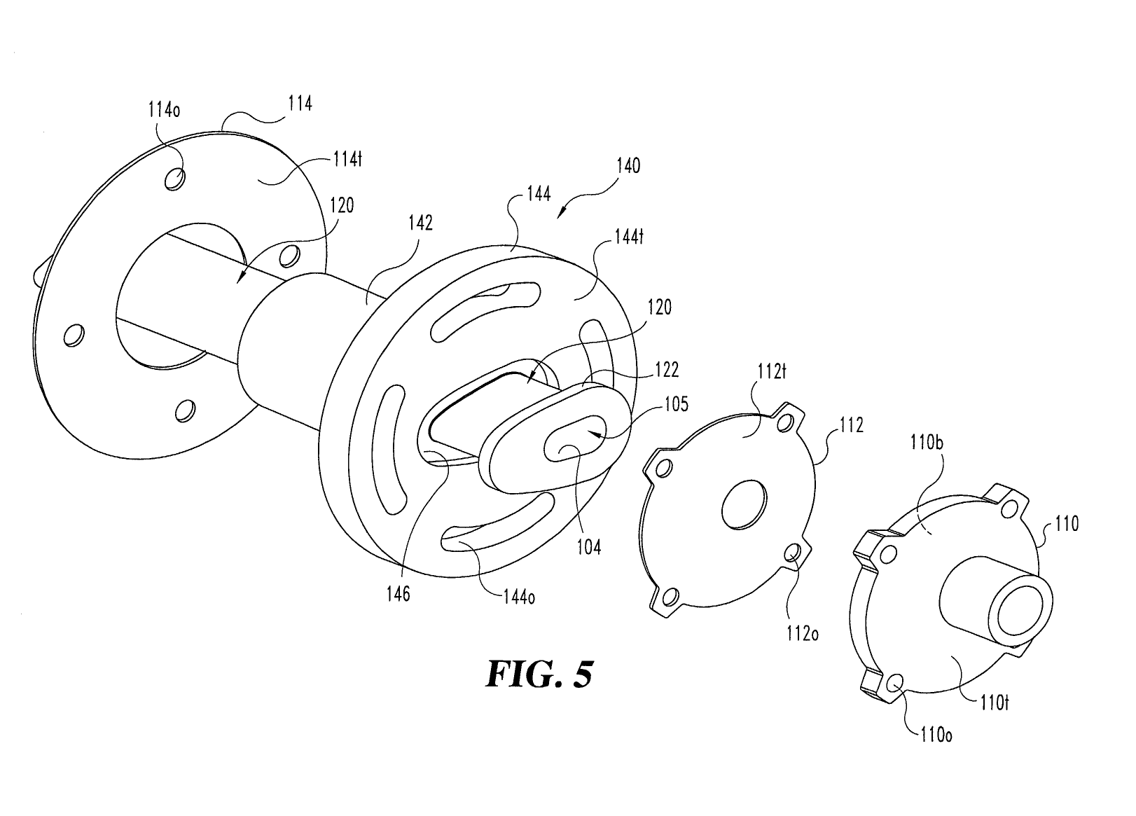

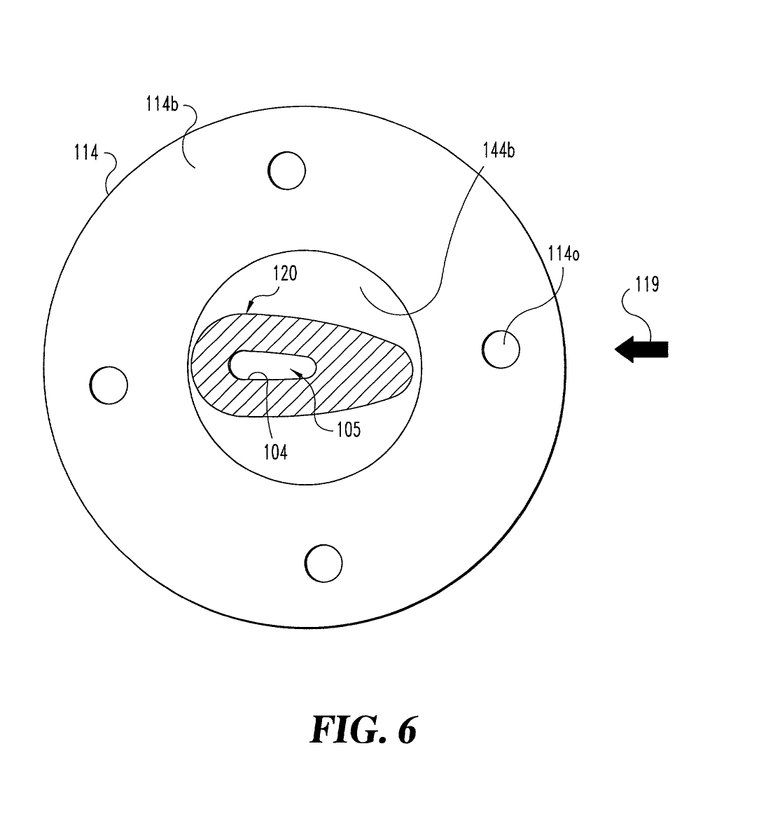

Referring to FIGS. 4-6 there are illustrated further details of the core piece 120 of FIG. 3 and its use in conjunction with a shield 140. As illustrated in FIGS. 5 and 6 the core piece 120 has an inner surface 104 beginning at mounting end 101 and extending toward flowpath end 102. The inner surface 104 defines a cavity 105 within core piece 120. The shield 140 has a first portion 142 that is preferably cylindrical or substantially airfoil shaped. It should be understood that while the core piece 120 is illustrated as being substantially airfoil shaped and the portion 142 of shield 140 is illustrated as being cylindrical, that a variety of shapes are contemplated as within the scope of the invention. The shield 140 also has an end portion 144 having a top surface 144t and a bottom surface 144b. The end portion 144 of shield 140 defines a mounting platform in the form of a socket or recess 146 for receiving mounting flange 122 of core piece 120. The end portion 144 also preferably includes a plurality of openings 144o for receiving connectors or fasteners (not illustrated) to assemble the core piece 120, shield 140, gaskets 112, 114 and retainer 110 as discussed below. It should be understood that the core piece 120 may be used by itself without the addition of the shield piece 140 in practicing the present invention.

Referring again to FIGS. 4-6 the core piece 120 is illustrated assembled to the shield piece 140 with upper and lower gaskets 112, 114 held to the shield 140 as well as a retainer 110. The end cap or retainer 110 has a bottom surface 110b and a top surface 110t. The retainer 110 includes the plurality of openings 110o for receiving connectors or fasteners to hold the retainer 110, upper gasket 112, shield 140, and lower gasket 114 together. The upper gasket 112 has a top surface 112t and a bottom surface 112b. A plurality of openings 112o are defined between the top surface 112t and bottom surface 112b for receiving the connectors. Similarly the lower gasket 114 has a top surface 114t and a bottom surface 114b with a plurality of openings 114o extending between the top surface 114t and bottom surface 114b.

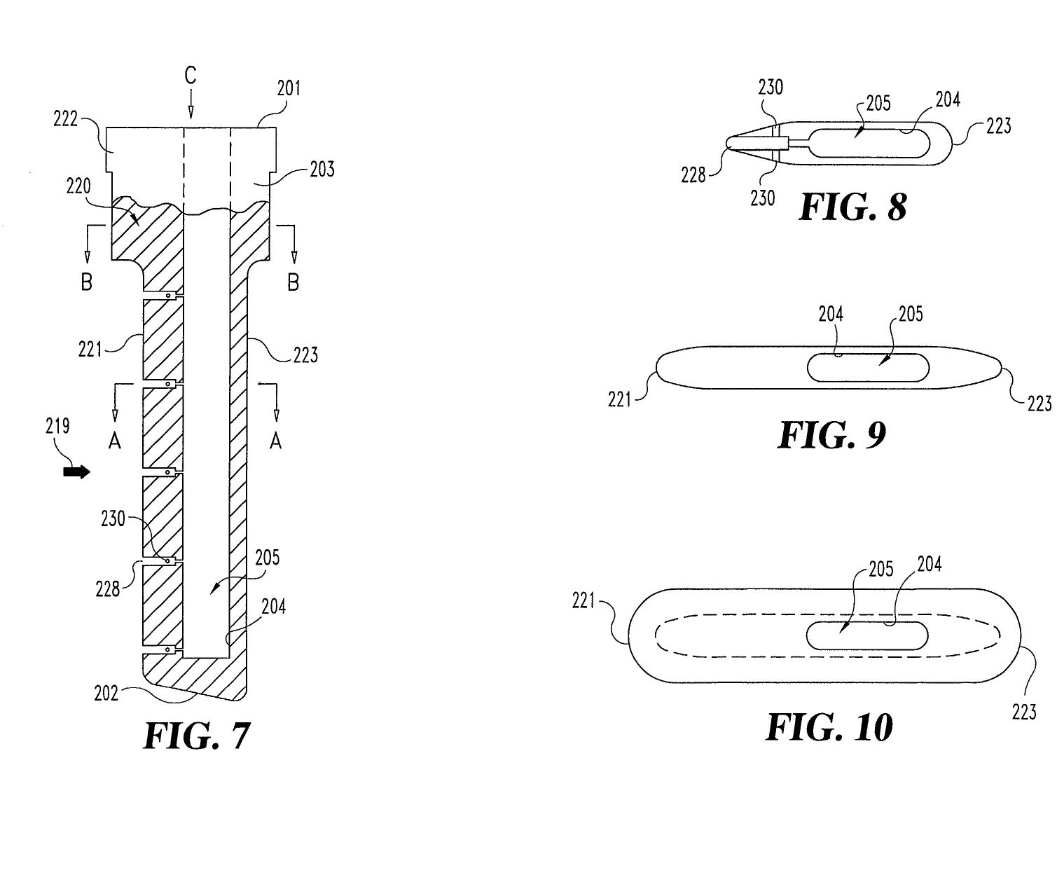

Referring now to FIGS. 7-10 there is illustrated a core piece 220 having an outer surface 203 extending between a mounting end 201 and a flowpath end 202. The outer surface 203 has a leading face 221 and a trailing face 223. The leading face 221 has a plurality of openings 228 defined therein. Each opening 228 preferably including associated bleed holes 230. The bleed holes 230 preferably being at ninety degree angles to the corresponding opening 228. It should be understood that the opening 228 is preferably aligned with the direction of flow as indicated by arrow 219. The mounting end 201 has a mounting flange 222 defined by the outer surface 203. The mounting end 201 is preferably at least partially open and the flowpath end 202 is preferably closed. An inner surface 204 extends from the at least partially open mounting end 201 toward the flowpath end 202 and defines a cavity 205. Cavity 205 is connected to the plurality of openings 228 so that leads or data transmission lines from whatever sensors are received in openings 228 may run from the openings 228 through the cavity 205 to the mounting end 201 and onward to various measurement instrumentation.

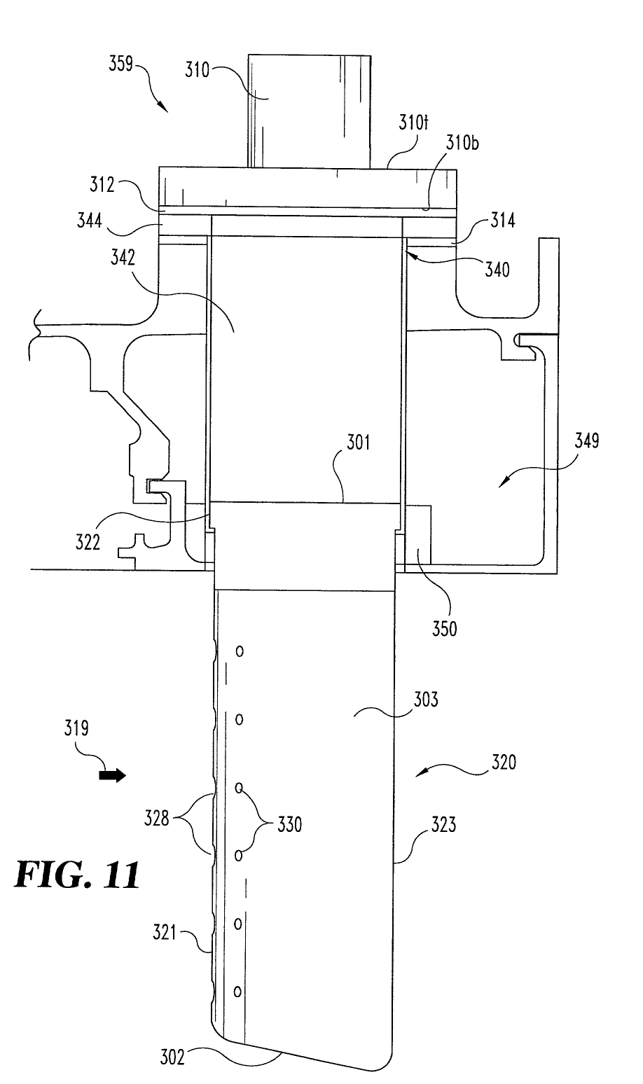

With reference to FIG. 11 there is illustrated another form of the present invention, similar to that illustrated in FIG. 4, wherein a core piece 320 and a shield 340 are mounted in a gas turbine engine. The core piece 320 has a leading face 321 and a trailing face 323. The leading face 321 preferably aligned with the direction of the flow as indicated by arrow 319. The leading face 321 has a plurality of openings 328 each opening having corresponding bleed holes 330. The core piece 320 has an outer surface 303 extending between an at least partially open mounting end 301 and a flowpath end 302. An inner surface (not illustrated) extends from the at least partially open mounting end 301 toward the flowpath end 302 and defines a cavity (not illustrated). The mounting end 301 having a mounting flange 322 preferably received within a socket in the second portion 342 of the shield 340. As illustrated there is a pad 350 for a seal to prevent air from the bypass area 349 from directly contacting the probe housing or core piece 320. Instead any flow in the bypass area 349 impinges upon the first portion 342 of shield 340. Shield 340 has a first portion 342 and an end portion 344. The shield 340 is held in place by a plurality of connectors or fasteners (not illustrated) extending through a plurality of openings (not illustrated) in the retainer 310, upper gasket 312, end portion 344 of shield 340, and lower gasket 314 similar to the assembly of FIG. 4. It should be understood that in one form the length of the flowpath of the hot gas portion indicated by arrow 319 is about 0.6 meters and the temperature of the hot gases is about 2,600 degrees Fahrenheit to about 2,800 degrees Fahrenheit (approximately 1,425-1,540 degrees Celsius). The bypass area 349 will typically have fluids of about 950 degrees Fahrenheit with minimal flow velocity. The temperature encountered in the external area 359 that includes retainer 310 is about 100 degrees Fahrenheit. Thus, there is a large radial temperature gradient from the flowpath end 302 of the core piece 320 to the retainer 310.

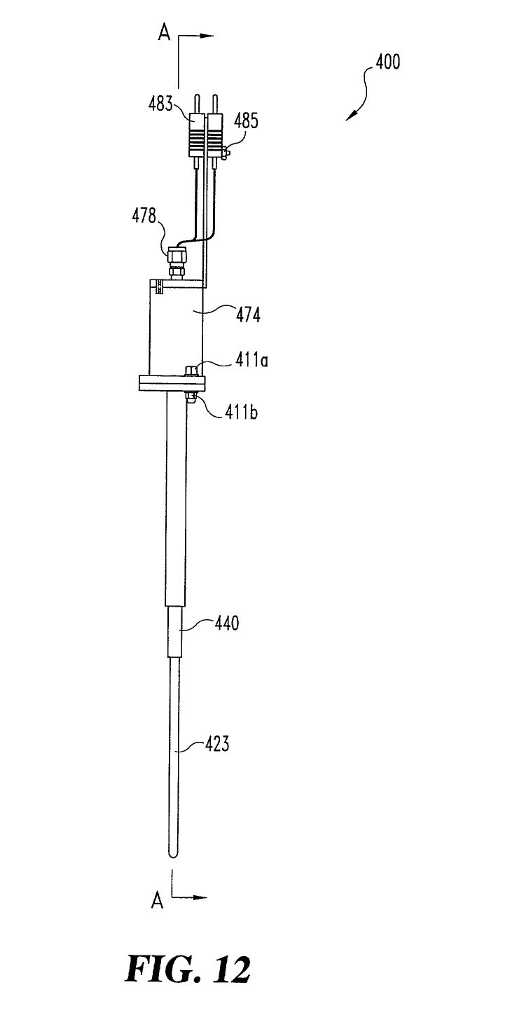

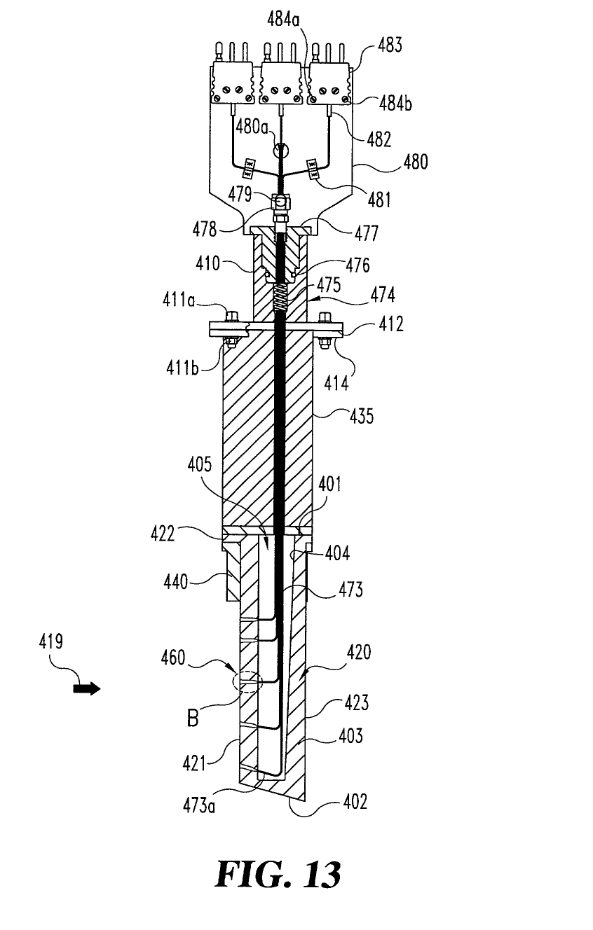

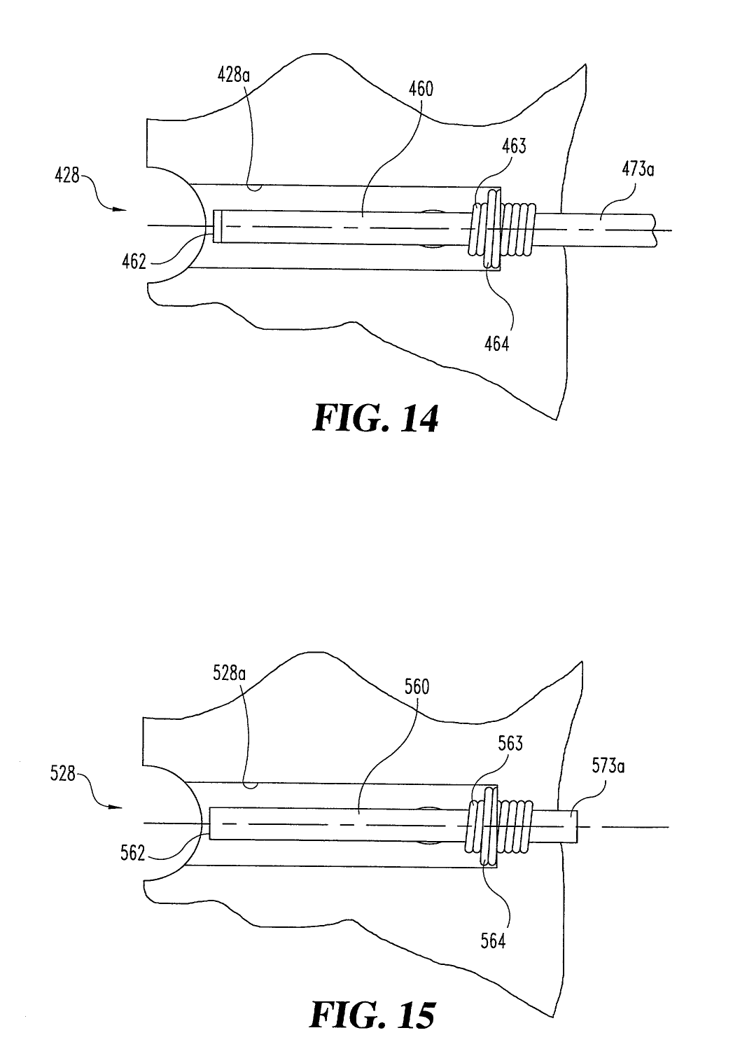

With reference to FIGS. 12-14 there is illustrated another form of the present invention of a rake assembly 400 having a plurality of sensors 460. The rake assembly 400 includes a core piece 420 having an outer surface 403 defining a leading face 421 and a trailing face 423. The outer surface 403 extends between a mounting end 401 and a flowpath end 402. The mounting end 401 includes a mounting flange 422. The mounting end 401 is at least partially open to an inner surface 404 defining a cavity 405. Cavity 405 extends from the mounting end 401 toward the flowpath end 402. The gas turbine engine flow, as indicated by arrow 419, impinges upon the leading surface 421 of rake 420 and enters openings 428 (see FIG. 14) having sensors 460 within. Walls 428a define each opening 428 receiving the sensor 460. The sensor 460 is a temperature sensor with a first end 462 having a closed tip ungrounded junction and a second end 463. A button 464 prevents the sensor 460 from sliding through the opening 428 into the cavity 405. The sensor 460 is preferably a type B thermocouple made of platinum wire. In one form of the invention the platinum wire has a diameter of 0.010 inches. A lead 473a connects the sensor 460 to the measuring instrumentation as will be discussed further below.

The mounting flange 422 of rake 420 preferably sits in a socket or recess of the shield 440. Shield 440 preferably extends radially outward as a case 435. The case 435 is connected to the engine and the body assembly 474 by one or more bolts 411a and nuts 411b. A gasket 414 is preferably used to connect the case 435 to the engine. Similarly a gasket 412 is preferably used to connect the body assembly 410 to the case 435. The leads 473 made up of individual leads 473a (connected to sensors 460) pass through the cavity 405 of rake piece 420 and through the interior of case 435 of shield 440 into the body assembly 474. The body assembly 474 includes an O-ring 476 and a spring 475 and a cap 477 within the retainer 410. The leads 473 pass through the body assembly 474 and through a compression fitting 478 having a Teflon ball 479.

When sealing the compression fitting 478, the leads 473 are preferably pulled tight so that the sensor 460 and the button 464 are seated within the openings 428 defined on the leading face 421 of the rake 420. After the leads are pulled tight through compression fitting 478 they pass along fan 480. Fan 480 preferably has a thickness of about 0.12 inches, however, it should be understood that other thicknesses and dimensions for both the fan and other components discussed herein are contemplated within the scope of the invention. Leads 473 may pass along one side or through hole 480a and along the other side of fan 480. The leads 473 may be secured using shim stock 481 as preferred and are connected by connector sleeves 482 to one or more type B connectors 483. The type B connectors 483 are secured to the fan 480 by a plurality of screws 484a, 484b and corresponding hex nuts 485. The individual leads 473a are preferably platinum thermocouple wire with a surrounding sheath having a diameter greater than that of the wire.

With reference to FIG. 15 there is illustrated a sensor 560 that may be used in the openings of one or more of the previously described forms of the invention. For example, the sensor 560 may be used in the opening 428 of the core piece 420. The sensor 560 is a pressure sensor such as pitot tube, preferably fabricated of platinum, having a first end 562 and a second end 563. The sensor 560 is received within an opening 528 defined by walls 528a. The sensor 560 is centered within the opening 528 and kept from sliding through into a cavity such as cavity 405 of core piece 420 by button 564. A lead 573a connects the sensor 560 to the appropriate transducer or other measurement apparatus.

The shape of the openings defined in the leading face of all of the above described embodiments of the rake may be varied as known to those of skill in the art. It should be understood that the shape of the openings may be circular, polygonal or oval with non symmetrical shapes having a number of possible orientations. It should also be understood that generally the openings are preferably circular to ninimize the disturbance to the flow and aid in ease of manufacture. It should be further understood that in some applications elongated or oval holes may be preferable to circular holes to, for example, accommodate swirl angle measurements of the hot gas flow path. When elongated holes are used, however, they will generally be oriented in a transverse direction to the leading edge. This effectively reduces the radius of the hole exposed to the thermally driven tensile stress field and increases the stress multiplier effect, thus increasing the possibility of failure. The openings of the embodiments described above preferably include bleed holes. The bleed holes are illustrated as being at ninety degree angles to the direction of the opening, the discharge coefficient for bleed holes at ninety degrees being known. It should be understood that bleed holes having other angles known to those of skill in the art may be used such as, for example, having bleed holes angled back away from the flow.

The location of the sensors received in the leading face of all of the above described embodiments of the rake assembly may also be varied as known to those of skill in the art. It should be understood that the leading tip of a sensor is preferably recessed back from the leading face, but the location may be varied without significantly impacting the accuracy of measurement for sensors measuring various quantities. It should also be understood that the sensor, the button used to retain the sensor within the opening, or both, will substantially block the flow from entering the cavity within the core piece. The button is preferably a platinum insert or inserts sized to fit within the opening in the rake, but too large to be drawn into the cavity within the rake. The use of a button is preferable to the attachment of the sensor (often made of platinum) directly to ceramic. In one preferred form the button is platinum wire wound around the sensor. It should be understood that in other forms the button may be a spacer of some material compatible with the ceramic.

It should be understood that a variety of sensors known to those of skill in the art are contemplated as within the scope of the invention. The temperature sensor, as discussed above, is preferably a Type B thermocouple with a platinum alloy sheath. But other thermocouples such as Type R or Type S are contemplated as within the scope of the invention as well as other materials such as platinum and another metal, tungsten-iridium and other materials known to those of skill in the art. Alternatively, the sensor may be an optical sensor. The sensor may measure temperature as with the thermocouple, or data such as yaw angle, or pressure (using pitot tubes).

As discussed previously, the core piece or elongated member is preferably airfoil shaped so as to minimize disturbance of flow and thus obtain a more accurate measurement. The core piece is preferably made of a ceramic selected from the group consisting of silicon carbide and silicon nitride. The core piece is more preferably made of SN281, a hot isostatically pressed high temperature silicon nitride (Si₃N₄) material manufactured by Kyocera, Inc. Material properties of SN281 are presented in Table I.

TABLE I

| | Data for | | |
|---|---|---|---|
| | Design | | Data for Design |
| Machined MOR | | K_{1C} (SEPB) | |
| RT avg. | 720 Mpa | RT (MPam½) | 6.2 |
| RT min. | 630 Mpa | 1371 C. | 5.8 |
| RT weibull | 11 | Young's Mod. | 298 GPa |
| | | 1400 C. | |
| 1400 C. avg. | 530 Mpa | Poisson Ratio | 0.28 |
| 1400 C. min. | 460 Mpa | CTE 10-6/C. | 3.2 |
| | | 40-1400 C. | |
| 1400 C. weibull | 15 | Thermal Cond. | 19 W/mK |
| | | 1400 C. | |
| As-Fired MOR | | Specific Heat | 1.22 J/gK |
| | | 1400 C. | |
| RT avg. | 550 Mpa | Density | 3.36 |
| RT min. | 460 Mpa | Flexural Strength | |
| | | 1400 C. | |
| RT weibull | 11 | Machined | 10 hr @ |
| | | | 400 MPa |
| | | | N = 70 |
| 1400 C. avg. | 480 Mpa | As-Fired | 10 hr @ |
| | | | 350 MPa |
| 1400 C. min. | 400 Mpa | Oxidation Resistance | 0.15 mg/cm² |
| 1400 C. weibull | 15 | | 100 hr @ |
| | | | 1500 C. |

In the two piece designs disclosed in the embodiments discussed above the shield piece may be a ceramic to minimize the likelihood of failure. The shield piece, however, is preferably a metallic material such as, but not limited to, Haynes 230 or MA 956. A metallic shield has greater conductivity and thus aids in dealing with any thermal gradient present. If considerations other than likelihood of failure are taken into account it may be preferable to use a metallic shield. In one form the shield piece's mounting platform or recess has a thirty inch radius. The radius provides a line contact zone between the shield and the core piece that may serve two functions. First, the mechanical loads between the two pieces will be carried through a well defined load path that will not change should the assembly be subject to minor distortions during engine operations. Second the line contact interface creates a thermal “resistor” between the core piece and the shield such that heat loss through the core piece mounting flange is minimized.

In the hostile operating environment of a gas turbine engine the thermal load is a primary stress driver causing failure in the rake assembly. Thus the two piece (core and shield) designs of the present invention are a means of operating the rake assembly in a more isothermal environment to effectively lower the maximum stress on the rake assembly. Specifically, the two piece designs attempt to minimize the cooling flow to the mounting flange end of the core piece such that the conduction mechanism in the core piece material may better normalize the radial thermal gradient. The two piece design divides the rake assembly into two sections such that the outer section, that extends from the mounting flange through the seal, minimizes or blocks the cooling flow from impinging the core piece containing the instrumentation openings. Therefore, the core piece operates in a more isothermal mode by not being exposed to the cooling flow field in which the conduction heat loss mechanism may dominate. The shield piece of the two piece design is subjected to the cooling flowpath and a relatively small portion of the gas path, but preferably has no surface features (such as instrumentation openings) present that act as stress risers. The heat transfer mechanisms between the core piece and the shield piece are free convection and radiation that are not as effective in transferring heat from the two piece design as the conduction mechanism present in the single-piece design.

The rake of the present invention is preferably only passively cooled and thus provides a more accurate measurement of temperature. It should be understood that passively cooled means that the rake is not actively cooled by air or water based cooling apparatus. Instead the rake is passively cooled, that is to say cooled only by the conduction and possible radiation present in any rake system that may be exposed to more than one operating temperature simultaneously. Additionally, even when measuring quantities such as pressure and yaw angle the rake of the present invention is preferable since it may still be used at more elevated temperatures without the added complexity of active cooling of the devices of the prior art. The rake of the present invention may be implemented advantageously in a variety of applications. In one form of the invention, the spray bar of an augmentor of a gas turbine engine is pulled and replaced with a rake assembly of the present invention. The rake may be used, for example, during testing to optimize performance during the design phase. But the rake of the present invention may also find use measuring quantities within the high temperature environment during operation. In addition to use within or after an augmentor, the rake of the present invention may also be used in other hostile operating environments known to those of skill in the art, including, but not limited to, after the high pressure turbine, within burner rigs, furnaces and rocket engines. The rake may be installed temporarily to replace a current fixture such as the spray bar, or it may be a permanent fixture.

While the invention has been illustrated and described in detail in the drawings and foregoing description, the same is to be considered as illustrative and not restrictive in character, it being understood that only the preferred embodiment has been illustrated and described and that all changes and modifications that come within the spirit of the invention are desired to be protected. In reading the claims, it is intended that when words such as “a,” “an,” “at least one,” or “at least a portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A probe housing, comprising:
an elongated ceramic member extending between a first end and a second end and having an exterior surface including a leading face adapted for receiving fluid flow thereon, the member having an internal cavity, the member having a plurality of openings defined on the leading face and extending between the exterior surface and the internal cavity and each of the plurality of openings configured to receive a sensor therein, and wherein the member is capable of withstanding hot gases impinging on said exterior surface at temperatures greater than 1200 degrees Celsius while the member is only passively cooled.

2. The housing of claim 1, wherein the first end is open and the second end is closed, and wherein the internal cavity beginning at the first end and extending toward the second end.

3. The housing of claim 1, wherein the member includes a cantilever mount at the first end.

4. The housing of claim 1, wherein the exterior surface is substantially airfoil shaped.

5. The housing of claim 1, wherein the member is formed of a ceramic material selected from the group consisting of silicon carbide and silicon nitride.

6. The housing of claim 1, wherein the member is capable of withstanding hot gases impinging on the exterior surface at temperatures greater than 1,500 degrees Celsius.

7. The housing of claim 1, wherein the plurality of openings are circularly shaped, and wherein each opening further including a pair of bleed holes.

8. The housing of claim 1, wherein the ceramic member is silicon carbide.

9. The housing of claim 1, wherein the ceramic member is silicon nitride.

10. The housing of claim 1, which further includes a temperature sensor located in each of the plurality of openings.

11. The housing of claim 10, wherein each of the sensors includes a platinum thermocouple, and wherein each thermocouple is a portion of a button member, and wherein each of the plurality of openings has one of the button members inserted therein, the button member preventing the flow of hot gas impinging on the exterior surface from entering the internal cavity through the plurality of openings.

12. The housing of claim 1, which further includes a pressure sensor located in each of the plurality of openings.

13. The housing of claim 1, which further includes at least one pressure sensor and at least one temperature sensor, and each of the plurality of openings has a sensor inserted therein.

14. The housing of claim 1, wherein the ceramic member is silicon nitride and the sensor is a temperature sensor including at least one platinum thermocouple received in at least one of the plurality of openings, and wherein the exterior surface is substantially airfoil shaped and has a cantilever mounting member.

15. A combination, comprising:
a substantially elongated silicon nitride sensor housing having a mounting end and a flowpath end and an internal cavity, the housing having a substantially airfoil shaped outer surface extending between the mounting end and the flowpath end and having a leading face adapted to be generally oriented to receive a fluid flow impinging thereon and a trailing face, the housing having a plurality of openings defined on the leading face extending between the internal cavity and the outer surface; and
a temperature sensor includes a thermocouple, the thermocouple is part of a button that is inserted into one of the plurality of openings.

16. The housing of claim 15, wherein the housing is capable of withstanding gases impinging on the outer surface at temperatures greater than 1200 degrees Celsius.

17. The housing of claim 15, wherein the housing is capable of withstanding gases impinging on the outer surface at temperatures greater than 1,500 degrees Celsius.

18. The housing of claim 15, wherein the housing is free of any active cooling network.

19. The housing of claim 15, wherein the outer surface further including a mounting flange at the mounting end.

20. The housing of claim 15, wherein the plurality of openings are circularly shaped and spaced a distance apart, each opening further including a pair of bleed holes.

21. The housing of claim 15, wherein the mounting end is open and the flowpath end is closed, and wherein the internal cavity beginning at the mounting end and extending toward the flowpath end.

22. The housing of claim 15, wherein:
the mounting end is open and the flowpath end is closed, and wherein the internal cavity beginning at mounting end and extending toward the flowpath end;
wherein the housing is free of any active cooling network; and
wherein the housing is capable of withstanding gases impinging on the outer surface at temperatures greater than 1200 degrees Celsius.

23. A high temperature capable probe housing, comprising:
a substantially elongated silicon nitride member, the member extending between an at least partially open mounting end and a closed flowpath end, the member having an inner surface and an outer surface, the inner surface defining a cavity beginning at the mounting end and extending toward the flowpath end, the outer surface extending between the mounting end and the flowpath end, the outer surface being substantially airfoil shaped and having a leading face upon which the flow generally impinges and a trailing face, the member having a plurality of openings defined on the leading face extending between the inner surface and the outer surface, and wherein each of the plurality of openings is configured to receive a sensor.

24. The housing of claim 23, wherein the housing is capable of withstanding gases impinging on the outer surface at temperatures greater than 1200 degrees Celsius.

25. The housing of claim 23, wherein the member is free of any active internal cooling system.
